(19) United States
(12) Patent Application Publication
(10) Pub. No.: US 2008/0272118 A1
(43) Pub. Date: Nov. 6, 2008

(54) KALEIDOSCOPIC CUP

(76) Inventor: CHING YUEH WANG WU, Tainan City (TW)

Correspondence Address: WANG WU CHING YUEH, P. O. BOX 90, Tainan City, 70499, TW

(21) Appl. No.: 11/743,675

(22) Filed: May 3, 2007

(51) Int. Cl. B65D 8/06; G02B 27/08

(52) U.S. Cl. 220/62.12

(57) ABSTRACT

A kaleidoscopic cup includes an outer cup, an inner cup, a turning base, a waterproof gasket and plural decorative members. The inner cup is placed in the outer cup, having a multi-sided body in a lower portion, and the sides of the multi-sided body are specially treated with mirror reflection to make its inner surface reflective. The inner cup has an annular insert groove in a bottom of an upper section on the multi-sided body. The waterproof gasket is placed between the outer cup and the turning base, and the decorative members are deposited on the recess of the turning base and that of the inner cup. Then the reflective inner surfaces of the multi-sides body of the inner cup reflect the images of the decorative members to give a kaleidoscopic visual effect to a person looking at the cup.

### BACKGROUND OF THE INVENTION

1. Field of the Invention

This invention relates to a kaleidoscopic cup, particularly to one provided with a kind of structure giving rise to a kaleidoscopic visual effect to a person looking at it.

2. Description of the Prior Art

Conventional cups are mainly used for containing water or drinks, not having special use, designed to have various shapes and different patterns with colors so as to arouse interests. But they are all static, hardly satisfying consumers' curiosities. Moreover, the colored patterns are generally simple and monotonous.

### SUMMARY OF THE INVENTION

The objective of this invention is to offer a kaleidoscopic cup provided with a kind of structure giving rise to a kaleidoscopic visual effect.

The features of the invention are an outer cup, an inner cup, a turning base, a waterproof gasket and plural decorative members. The outer cup has an open bottom and an annular upper insert edge and an annular slide groove in an outer surface. The inner cup is fixed in the outer cup, made transparent and having an interior chamber, a multi-sided body formed in a lower portion. The multi-sided body has its sides specially treated with mirror reflection so that the inner surface of the sides can reflect, and a recess formed in its bottom. The turning base is installed on the recess of the outer cup and the inner cup, provided with a recess and an upper annular insert edge. The waterproof gasket is placed between the outer cup and the turning base, and the decorative members are deposited in the recess of the inner cup and the turning base.

### BRIEF DESCRIPTION OF DRAWINGS

This invention will be better understood by referring to the accompanying drawings, wherein:

FIG. 1 is an exploded perspective view of a preferred embodiment of a kaleidoscopic cup in the present invention;

FIG. 2 is a perspective view of the preferred embodiment of a kaleidoscopic cup in the present invention

FIG. 3 is a cross-sectional view of the preferred embodiment of a kaleidoscopic cup in the present invention; and,

FIG. 4 is an upper view of the preferred embodiment of a kaleidoscopic cup in the present invention.

### DETAILED DESCRIPTION OF THE PREFERRED EMBODIMENT

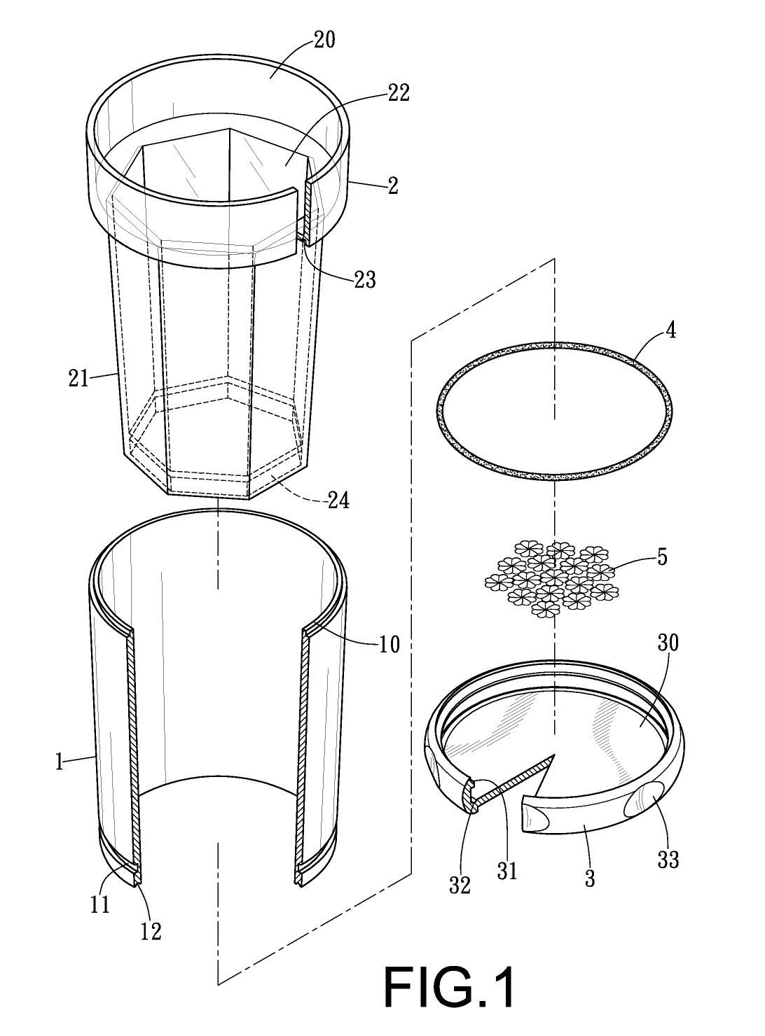

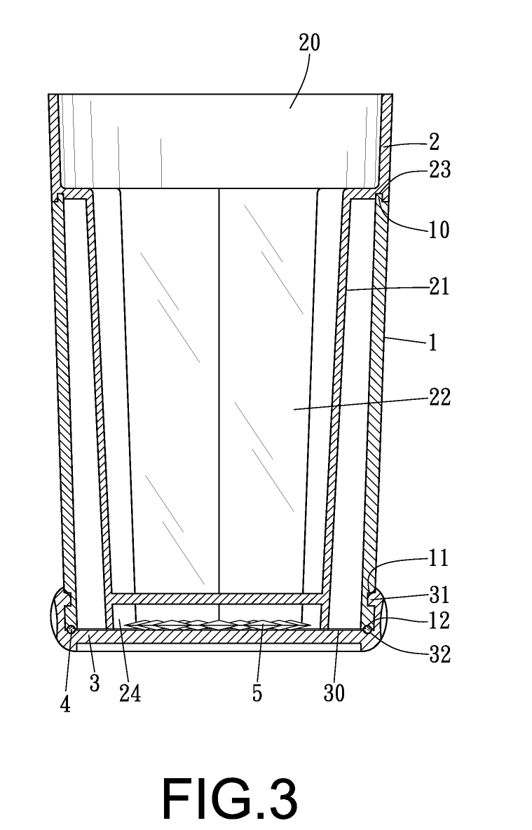

A preferred embodiment of a kaleidoscopic cup in the present invention, as shown in FIGS. 1, 2 and 3, includes an outer cup 1, an inner cup 2, a turning base 3, a waterproof gasket 4 and plural decorative members 5 as main components combined together.

The outer cup 1 has an open bottom, a flange 10 formed in an upper edge and an annular groove 11 formed in an outer surface of a lower end and an annular bottom edge 12.

The inner cup 2 is deposited in the outer cup 1, transparent and provided with a chamber 20 in the interior, and a multi-sided body 21 with an outer surface 22 of the sides specially treated with mirror reflection to make the inner reflective surface 22 of the sides, an annular groove 23 formed in an annular bottom of an upper section and a recess 24 formed in the bottom.

The turning base 3 is combined with the annular bottom of the outer cup 1 and the inner cup 2, provided with a recess 30 on the bottom, an annular fit edge 31 formed in an upper edge, an annular groove 32 formed in the upper surface of the recess 30, and a plurality of concave faces 33 formed to space apart on an outer surface.

The waterproof gasket 4 is fitted with the annular bottom edge 12 and in the annular groove 32 of the turning base 3.

A plurality of decorative members 5 are deposited in the recess 2 of the inner cup 2 and the recess 30 of the turning base 3, having various shapes such as stars, moons, flowers, etc. of different colors.

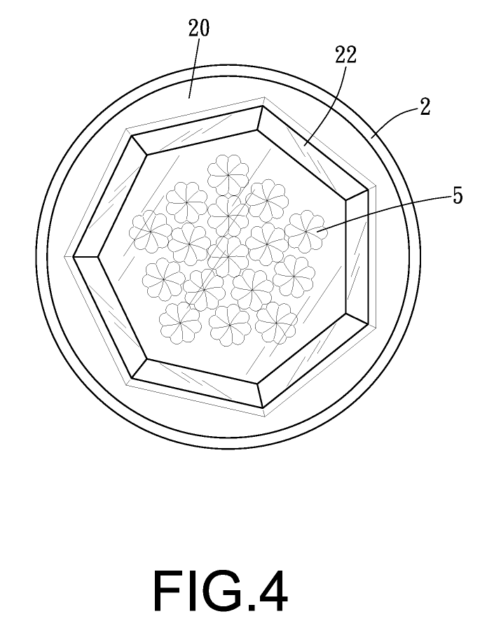

In assembling, referring to FIGS. 1 to 4, firstly the waterproof gasket 4 is inserted in the annular groove 32 of the turning base 3, and then the decorative members 5 are placed in the recess 30 of the turning base 3. Next, the inner cup 2 is placed in the outer cup, with the multi-sided body 21 completely in the outer cup 1, and with the upper edge 10 of the outer cup fitting in the annular groove 23 of the inner cup 2, with the upper portion of the inner cup 2 resting on the outer cup 1. Then the outer cup 1 and the inner cup 2 are fused together by means of supersonic process, After that, the turning base 3 is combined with the bottom of the outer cup 1 and the inner cup 2, with the annular fit edge 31 of the turning base 3 slidably fitting in the annular groove 11 of the outer cup 1. So the turning base 3 can turn freely relative to the outer cup 1 and the inner cup 2. The waterproof gasket 4 positioned in the annular groove 32 of the turning base 3 has its upper edge fitting in the annular groove 12 of the outer cup 1, preventing water from leaking in the outer cup 1 through the turning base 3. And the decorative members 5 are positioned in the recess 30 of the turning base 3 and in the recess 24 of the inner cup 2, finishing the assembly of the kaleidoscopic cup.

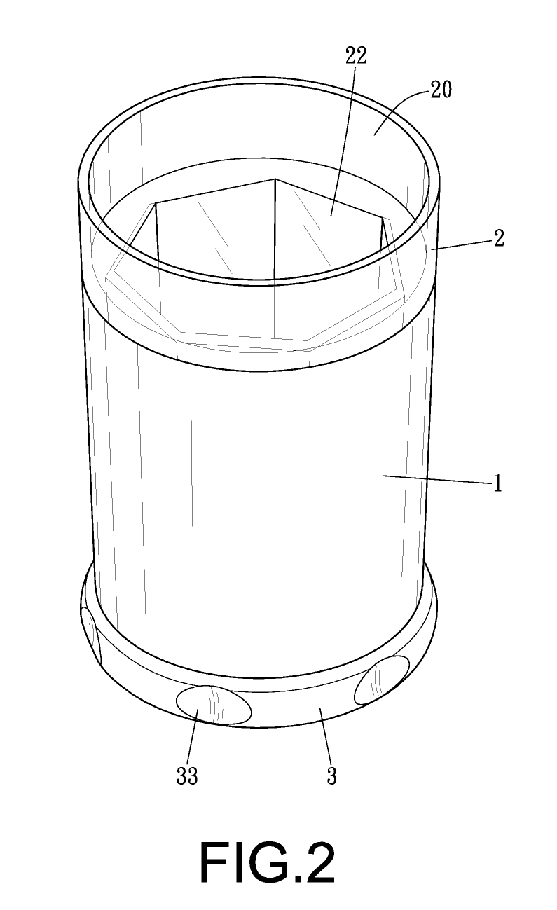

In using, referring to FIGS. 2, 3 and 4, liquid can be stored in the inner cup, and in addition, the reflective surfaces 22 of the multisided body 21 of the inner cup 2 can reflect the images of the decorative members 5 on the recess 30 of the turning base 3,

And if the turning base 4 is turned, the images may move around, producing kaleidoscopic effect to a person looking at the cup, boosting much interest for a user.

While the preferred embodiment of the invention has been described above, it will be recognized that various modifications may be made therein and the appended claims are intended to cover all such modifications that may fall within the spirit and scope of the invention.

What is claimed is:

1. A kaleidoscopic cup comprising:
an outer cup having an open bottom, an annular upper edge and an annular slide groove formed in an outer lower surface;
an inner cup placed in said outer cup, made transparent and having a chamber in its interior, a multi-sided body formed in a lower portion, sides of said multi-sided body having an outer surface specially treated with mirror reflection so that its inner surface may reflect, said inner cup having an annular insert groove formed in a lower end of an upper section on said multi-body, said multi-sided body having a recess formed in its bottom;
a turning base combined with said bottom of said outer cup and of said inner cup and provided with a recess and an annular insert edge formed in an upper end;
a waterproof gasket fitted between said outer cup and said turning base; and,
a plurality of decorative members positioned on said recess of said inner cup and that of said turning base.

2. The kaleidoscopic cup as claimed in claim 1, wherein said inner cup and said outer cup are fused together by means of supersonic welding process.

3. The kaleidoscopic cup as claimed in claim 1, wherein said outer cup is provided with an annular groove in its annular bottom surface, and said turning base is provided with an annular groove in said recess for said waterproof gasket to fit therein.

4. The kaleidoscopic cup as claimed in claim 1, wherein said turning base is provided with a plurality of concave faces spaced apart on its outer surface.

5. The kaleidoscopic cup as claimed in claim 1, wherein said decorative members have various shapes and colors.
